(19) United States
(12) Patent Application Publication
(10) Pub. No.: US 2007/0101126 A1
(43) Pub. Date: May 3, 2007

(54) User/service authentication methods and apparatuses using split user authentication keys

(76) Inventors: Byeong Cheol Choi, Daejeon-city (KR); Dong Il Seo, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/520,172

(22) Filed: Sep. 13, 2006

(30) Foreign Application Priority Data
Oct. 19, 2005 (KR) 10-2005-0098691

(51) Int. Cl. H04L 9/00

(52) U.S. Cl. 713/156

(57) ABSTRACT

User/service authentication methods and apparatuses using split user authentication keys are provided. A user authentication key is generated using user's personal information including an identification number and bio information, the generated user authentication key is split into a plurality of keys, and a request for authentication of a user that uses a first user authentication key provided to the user from among the plurality of split user authentication keys is authenticated using the other user authentication keys. After the authentication is successful, a service authentication is performed according to a result obtained by recombining the split user authentication keys, so that when some of distributed service authentication keys are lost or stolen, since original user authentication information cannot be restored, user information is prevented from being exposed, damage caused by a lost or stolen authentication key owing to double authentication is reduced, security protection is reinforced using a security channel formed through the service authentication, and communication exchanges such as electronic commerce over Internet are safer.

### BACKGROUND OF THE INVENTION

This application claims the benefit of Korean Patent Application No. 10-2005-0098691, filed on Oct. 19, 2005, in the Korean Intellectual Property Office, the disclosure of which is incorporated herein in its entirety by reference.

1. Field of the Invention

The present invention relates to security protection, and more particularly, to user/service authentication methods and apparatuses using split user authentication keys.

2. Description of the Related Art

Methods of identifying a user and service are frequently used on the Internet in electronic commerce, stock market, document issuance, etc. An identification number, a certificate, or a combination of an identification number and a certificate is generally used to identify real names of transaction parties.

However, such a method involves a risk that the identification number or the certificate can be lost, or stolen while using it during various transactions.

That is, the conventional method of identifying real names of transaction parities involves a risk that the certificate or the identification number can be stolen by third parties.

### SUMMARY OF THE INVENTION

The present invention provides user/service authentication methods and apparatuses using split user authentication keys although information necessary for identifying real names is stolen.

According to an aspect of the present invention, there is provided a user authentication method using split user authentication keys, comprising: generating a user authentication key using user's personal information including an identification number and bio information; splitting the generated user authentication key into a plurality of keys; and authenticating a request for authentication of a user that uses a first user authentication key provided to the user from among the plurality of split user authentication keys using the other user authentication keys.

According to another aspect of the present invention, there is provided a user and service authentication method using split user authentication keys, in which an authentication of a user that requests service is performed and a service authentication is performed according to the result obtained by the user authentication, the method comprising: authenticating a request for authentication of the user that uses a first user authentication key provided to the user from among a plurality of split user authentication keys using the other user authentication keys; recombining the split user authentication keys if the user authentication is successfully performed; generating a service authentication key using the recombined user authentication key and transferring the service authentication key to the user; and if the user requests to provide service and transfers the service authentication key, authenticating the service request by identifying the service authentication key.

According to another aspect of the present invention, there is provided a user authentication apparatus using split user authentication keys, comprising: a user authentication key generator generating a user authentication key using user's personal information including an identification number and bio information, and splitting the generated user authentication key into a plurality of correlated keys; and a user authenticator authenticating a request for authentication of a user that uses a first user authentication key provided to the user from among the plurality of split user authentication keys using the other user authentication keys according to correlations of the split user authentication keys.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a flowchart illustrating a user authentication method using split user authentication keys according to an embodiment of the present invention;

FIG. 2 is a flowchart illustrating a split user authentication method and a service authentication method according to an embodiment of the present invention;

FIG. 3 is a block diagram illustrating a user authentication apparatus using split user authentication keys according to an embodiment of the present invention;

FIG. 4 illustrates an operation of generating a user authentication key, splitting the generated user authentication key, recombining the split user authentication keys, and regenerating a service authentication key according to an embodiment of the present invention; and

FIG. 5 is a flowchart illustrating an operation of authenticating a user and service according to an embodiment of the present invention.

### DETAILED DESCRIPTION OF THE INVENTION

Hereinafter, exemplary embodiments of the present invention will be described in detail with reference to the accompanying drawings.

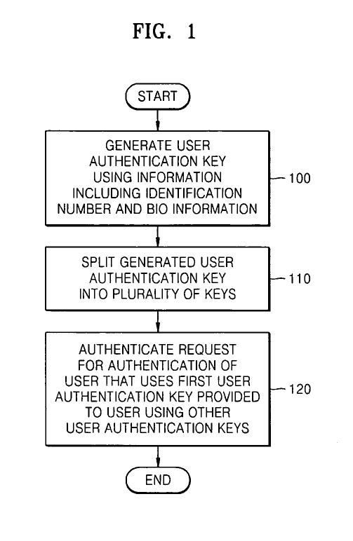

FIG. 1 is a flowchart illustrating a user authentication method using split user authentication keys according to an embodiment of the present invention. Referring to FIG. 1, a user authentication key is generated using information including an identification number and bio information (Operation 100). The generated user authentication key is split into a plurality of keys (Operation 110). A request for authentication of a user that uses a first user authentication key provided to the user among the plurality of split user authentication keys is authenticated using the other user authentication keys (Operation 120).

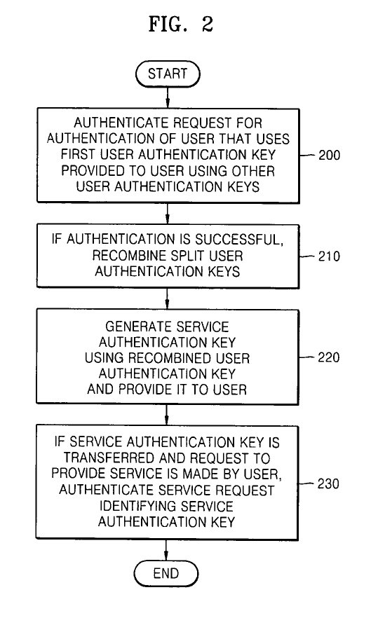

FIG. 2 is a flowchart illustrating a split user authentication method and a service authentication method according to an embodiment of the present invention. Referring to FIG. 2, a request for authentication of a user that uses a first user authentication key provided to the user among the plurality of split user authentication keys is authenticated using the other user authentication keys (Operation 200). If the authentication is successful, the split user authentication keys are recombined (Operation 210). A service authentication key is generated using the recombined user authentication keys and is provided to the user (Operation 220). If the service authentication key is transferred and a request to provide service is made by the user, the service request is authenticated by identifying the service authentication key (Operation 230).

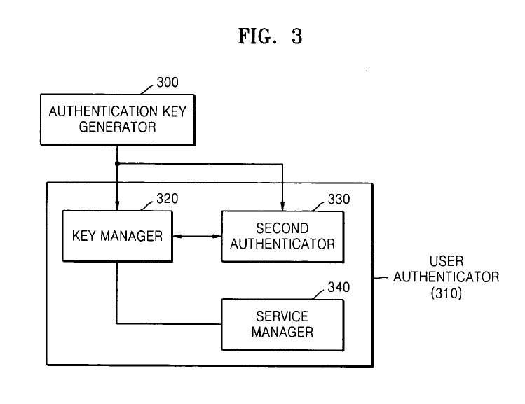

FIG. 3 is a block diagram illustrating a user authentication apparatus using a split user authentication key according to an embodiment of the present invention. Referring to FIG. 3, the user authentication apparatus comprises a user authentication key generator 300 that generates a user authentication key using user's personal information including an identification number and bio information of a user, and splits the generated user authentication key into a plurality of correlated keys, and a user authenticator 310 that authenticates a request for authentication of the user that uses a first user authentication key provided to the user from among the plurality of split user authentication keys using the other user authentication keys according to correlations of the split user authentication keys.

The user authenticator 310 comprises a key manager 320 that receives the request for authentication of the user, performs a first authentication of the first user authentication key using a second user authentication key from among the plurality of split user authentication keys, and requests a second authentication by transmitting the result obtained by the first authentication, the first use authentication key, and the second authentication key, and a second authenticator 330 that performs the second authentication using a third user authentication key from among the plurality of split user authentication keys as per the request for the second authentication from the key manager 320.

The user authenticator 310 further comprises a service manager 340 that determines whether a request for service from the authenticated user is authentic and authenticates the service requested by the authenticated user.

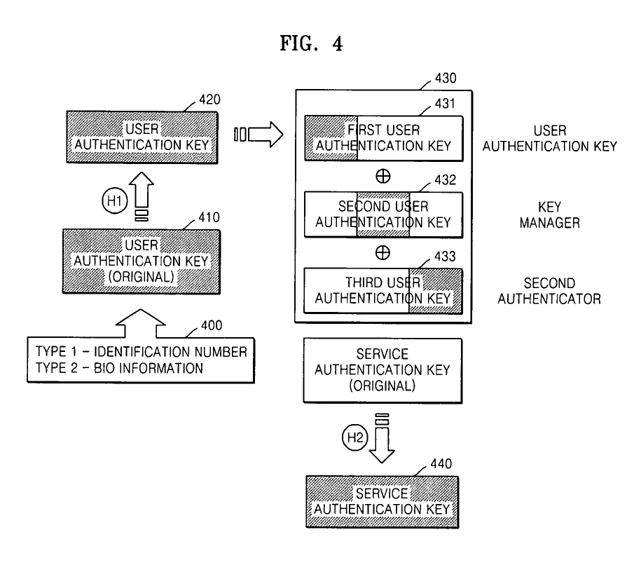

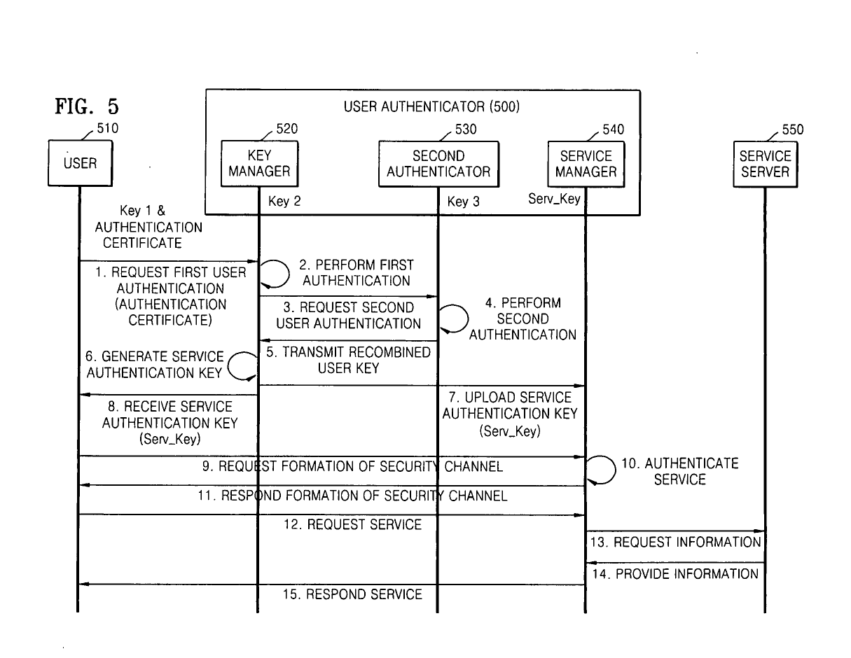

The operation of the present invention will now be in detail described with reference to FIGS. 4 and 5.

FIG. 4 illustrates an operation of generating a user authentication key, splitting the generated user authentication key, recombining the split user authentication keys, and regenerating a service authentication key according to an embodiment of the present invention. Referring to FIG. 4, the authentication key generator 300 generates a (original) user authentication key 410 using user's personal information including an identification number and bio information (Operation 100). The bio information includes at least one of a fingerprint, an iris, a blood type, gene information such as DNA, etc.

Original data of the generated user authentication key 410 is generated as a user authentication key 420 through a hashing process H1. The original data of the user authentication key 410 cannot be regenerated using the user authentication key generated through the hashing process H1.

The user key generator 300 splits the generated user authentication key 420 into a plurality of keys (Operation 110). Each of the plurality of split user authentication keys includes information on the other split user authentication keys. That is, the other split user authentication keys identify that one of the plurality of split user authentication keys is split and generated from the same user authentication key. To this end, a distributed orthogonal method is used to split the user authentication key 420 into a plurality of keys, and some of the plurality of split user authentication keys include information on the other user authentication keys.

A user authentication key 430 is split into first, second, and third user authentication keys 431 through 433. The first user authentication key 431 is provided to the user, the second user authentication key 432 is provided to the key manager 320, and the third user authentication key 433 is provided to the second authenticator 330 to authenticate the user. This will be in detail described with reference to FIG. 5.

The three user authentication keys 431 through 433 are recombined by the key manager 320, regenerated as the (original) user authentication key 410, and generated as a service authentication key 440 through a hashing process H2 (Operation 220).

The user authenticator 310 authenticates a request for authentication of the user that uses the first user authentication key 431 provided to the user from among the plurality of split user authentication keys using the second and third user authentication keys 432 and 433 (Operation 120).

FIG. 5 is a flowchart illustrating an operation of authenticating a user and service according to an embodiment of the present invention. The operation is performed through a communication network such as the Internet.

Referring to FIG. 5, when a user 510 transfers a first user authentication key Key1 and makes a request for authenticating that the user 510 is an authentic user, a key manager 520 included in a user authenticator 500 receives the first user authentication key Key1 and performs a first authentication of the user 510 using a second using authentication key Key2 included in the key manager 520.

If an authentication certificate issued to the user 510 is transferred to the key manager 520 along with the first user authentication key Key1, the key manager 520 authenticates the authentication certificate. The user authentication can be continuously performed using the user authentication keys Key1 and Key 2 only when the key manager 520 successfully authenticates the authentication certificate.

The distributed orthogonal method is used to split the user authentication key into a plurality of keys performed in Operation 110. Since some of the plurality of split user authentication keys include information on the other split user authentication keys, the key manager 520 performs the first authentication of the user 510 based on information on the first user authentication key Key 1 included in the second user authentication key Key2. This process is the first authentication.

After the key manager 520 successfully authenticates the user 510, the key manager 520 makes a request for a second authentication of the user 510 using the first user authentication key Key1 transferred from the user 510 to a second authenticator 530 including a third authentication key Key3, and the second user authentication key Key2 included in the key manager 520.

The second authenticator 530 receives the first and second user authentication keys Key1 and Key2 and performs the second authentication of the user 510 by authenticating that the first and second user authentication keys Key1 and Key2 are split from the same user authentication key using the third user authentication key Key3.

After the second authenticator 530 successfully authenticates the user 510, a service authentication requested by the user 510 is performed. The second authenticator 530 recombines the first, second, and third user authentication keys Key1, Key2, and Key3 into the user authentication key (Operation 210). The method of splitting the user authentication key can be used to recombine the split user authentication keys. The recombined user authentication key is an original service authentication key.

The key manager 520 performs a hashing H2 on the recombined user authentication key and generates the service authentication key 440. The generated service authentication key 440 is transferred to the user 510. The key manager 520 transfers the service authentication key 440 to a service manager 540.

The user 510 requests the service manager 540 to form a security channel in order to request desired service and simultaneously transfers the received service authentication key 440 to the service manager 540. The service manager 540 authenticates that the authentic user requests the service using the received service authentication key 440 (Operation 230). The service manager 540 forms the security channel and transmits a response to the request for forming the security channel to the user 510.

After the security channel is formed, if the service manager 540 receives a service request from the user 510, the service manager 540 transfers the service request to a server 550 providing the service and responds to the user 510 according to a response from the server 550.

If the user 510 does not request the service manager 540 to form the security channel but requests the service by transferring the service authentication key 440, the service manager 540 authenticates the service and, if the service authentication is successful, responds to the service requested by the user 510.

According to the present invention, a double authentication and a security channel formed through a service authentication reinforces security protection. A user and an authentication apparatus according to the present invention manage a user authentication key, thereby reducing damage caused by the lost and stolen user authentication key.

In particular, a distributed orthogonal keys management is used to distribute the use authentication key. Although a service authentication key is lost or stolen, original user authentication information cannot be restored, thereby preventing the user authentication information from being exposed.

The present invention can be realized using a server or a suitable program operated in the server. The authentication key generator 300, the key managers 320 and 520, the second authenticators 330 and 530, and the service managers 340 and 540 illustrated in FIGS. 3 and 5 can be realized by a single server, or separate servers connected through a communication network.

Although the present invention has been described with respect to the Internet as an example of the communication network, it is obvious that the present invention is applicable to various fields including a public switched telephone network (PSTN).

According to the present invention, a user authentication key is generated using user's personal information including an identification number and bio information, the generated user authentication key is split into a plurality of keys, and a request for authentication of a user that uses a first user authentication key provided to the user from among the plurality of split user authentication keys is authenticated using the other user authentication keys. After the authentication is successful, a service authentication is performed according to a result obtained by recombining the split user authentication keys, so that when some of distributed service authentication keys are lost or stolen, since original user authentication information cannot be restored, user information is prevented from being exposed, damage caused by a lost or stolen authentication key owing to double authentication is reduced, security protection is reinforced using a security channel formed through the service authentication, and communication exchanges such as electronic commerce over Internet are safer.

It would be obvious to those of ordinary skill in the art that each of the above operations of the present invention may be embodied by hardware or software, using general program techniques.

Also, some of the above operations of the present invention may be embodied as computer readable code in a computer readable medium. The computer readable medium may be any recording apparatus capable of storing data that is read by a computer system, e.g., a read-only memory (ROM), a random access memory (RAM), a compact disc (CD)-ROM, a CD-rewritable (RW), a magnetic tape, a floppy disk, a hard disk drive (HDD), an optical data storage device, a magnetic-optical storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A user authentication method using split user authentication keys, comprising:
generating a user authentication key using user's personal information including an identification number and bio information;
splitting the generated user authentication key into a plurality of keys; and
authenticating a request for authentication of a user that uses a first user authentication key provided to the user from among the plurality of split user authentication keys using the other user authentication keys.

2. The method of claim 1, wherein, if an authentication certificate issued to the user is transferred along with the request for authentication of the user, the request for authentication of the user is authenticated only when the authentication certificate is successfully authenticated.

3. The method of claim 1, wherein a distributed orthogonal method is used to split the user authentication key into the plurality of keys, and some of the plurality of split user authentication keys include information on the other user authentication keys, and
the request for authentication of the user is authenticated based on information on the first user authentication key included in the other user authentication keys.

4. The method of claim 1, wherein the user's personal information including the identification number and bio information is hashed to generate the user authentication key.

5. The method of claim 1, wherein the bio information includes at least one of a fingerprint, an iris, a blood type and gene information.

6. The method of claim 1, wherein the request for authentication of the user is transferred to a predetermined first authentication server,
wherein the authenticating of the request for authentication of the user comprises:
the first authentication server performing a first authentication of the first user authentication key using a second user authentication key provided to the first user authentication server among the plurality of split user authentication keys;
if the first authentication is successfully performed, transferring the first and second user authentication keys and the successful authentication information to a predetermined second authentication server and requesting a second authentication of the user; and
the second authentication server performing the second authentication using a third user authentication key provided to the second authentication server among the plurality of split user authentication keys.

7. A user and service authentication method using split user authentication keys, in which an authentication of a user that requests service is performed and a service authentication is performed according to the result obtained by the user authentication, the method comprising:
authenticating a request for authentication of the user that uses a first user authentication key provided to the user from among a plurality of split user authentication keys using the other user authentication keys;
recombining the split user authentication keys if the user authentication is successfully performed;
generating a service authentication key using the recombined user authentication key and transferring the service authentication key to the user; and
if the user requests to provide service and transfers the service authentication key, authenticating the service request by identifying the service authentication key.

8. The method of claim 7, wherein the recombined user authentication key is hashed to generate the service authentication key.

9. The method of claim 7, wherein the request for authentication of the user is authenticated using information on some of the split user authentication keys included in the other split user authentication keys.

10. A user authentication apparatus using split user authentication keys, comprising:
a user authentication key generator generating a user authentication key using user's personal information including an identification number and bio information, and splitting the generated user authentication key into a plurality of correlated keys; and
a user authenticator authenticating a request for authentication of a user that uses a first user authentication key provided to the user from among the plurality of split user authentication keys using the other user authentication keys according to correlations of the split user authentication keys.

11. The apparatus of claim 10, wherein the user authentication key generator authenticates the user authentication key including the identification number and bio information using a hashing function.

12. The apparatus of claim 10, wherein the user authentication key generator uses a distributed orthogonal method to split the user authentication key into the plurality of keys so that the split user authentication keys have correlations.

13. The apparatus of claim 10, wherein the user authenticator comprises:
a key manager receiving the request for authentication of the user, performing a first authentication of the first user authentication key using a second user authentication key among the plurality of split user authentication keys, transferring the first and second user authentication keys and the result obtained by the first authentication, and requesting a second authentication of the user; and
a second authenticator performing the second authentication using a third user authentication key among the plurality of split user authentication keys.

14. The apparatus of claim 13, wherein the user authenticator further comprises a service manager determining whether a request for service from the authenticated user is authentic and performing a service authentication,
the second authenticator recombines the first, second, and third user authentication keys and transfers the recombined user authentication key to the key manager,
the key manager generates a service authentication key using the recombined user authentication key and transfers the service authentication key to the user and the service manager; and
if the service manager receives a request to provide service and the service authentication key from the user, the service manager authenticates the service request by identifying the service authentication key.

15. The apparatus of claim 14, wherein the key manager hashes the user authentication key to generate the service authentication key.
